(19) United States
(12) Patent Application Publication
(10) Pub. No.: US 2006/0016751 A1
(43) Pub. Date: Jan. 26, 2006

(54) Method of concentrating pulp mill extracts

(75) Inventors: Omar F. Ali, Richmond Hill, GA (US); Jian Li, Richmond Hill, GA (US); H. Scott Rogers, Fernandina, FL (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Rayonier Products and Financial Services Company

(21) Appl. No.: 10/897,934

(22) Filed: Jul. 23, 2004

(51) Int. Cl. B01D 61/04

(52) U.S. Cl. 210/644; 210/634; 210/652; 210/650; 210/651; 210/655; 210/653; 210/654; 162/29; 162/30.11; 162/42

(57) ABSTRACT

A process for separating organic components from a pulp mill waste stream comprising the steps of washing a cellulose pulp to obtain an aqueous extraction liquor containing organic components, and separating at least a portion of said organic components from the extraction liquor by passing the extraction liquor through at least one nanofiltration membrane. The process may be used in conjunction with a variety of pulp mill processes, including kraft cooking processes, hot caustic extraction processes, sulfite cooking processes, and bleaching processes.

### FIELD OF THE INVENTION

This invention relates to the treatment of pulp mill extracts and extract streams. More particularly, the invention relates to the concentration and dewatering of pulp mill extract streams.

### BACKGROUND OF THE INVENTION

Pulp mill process operations generate a variety of waste streams, many of which contain waste products in dilute aqueous solutions or suspensions. For instance, the extract stream for a hot caustic extraction (HCE) operation comprises an aqueous stream of dissolved wood extractives, ligninsulfonates, and carbohydrates, a stream of spent sulfite liquor (SSL) comprises an aqueous stream of dissolved, wood extractives, ligninsulfonates, and carbohydrates, a stream of kraft black liquor (KBL) comprises an aqueous stream of wood extractives, kraft lignin, and carbohydrates, and a stream of bleach effluent comprises an aqueous stream of lignin and carbohydrates.

The large organic content of the HCE, SSL, and KBL streams may be used as an energy source in a recovery boiler or furnace but those streams must first be dewatered in order to concentrate the organics sufficiently to form a combustible solution. Dewatering has most often been accomplished by evaporating the aqueous portion of the waste streams until the organic matter of the stream is concentrated to a combustible level. However, the evaporation of water from waste streams is energy intensive and the volume of the dilute waste streams requires the use of large and capital intensive evaporating equipment.

The large organic content of a bleach effluent stream may be eliminated through conventional wastewater treatment methods but the high COD and BOD content of the bleaching waste streams requires a large capacity of wastewater treatment. Conventional evaporators and recovery are not used to dewater bleach streams because of low solids concentration and chloride in these streams.

It is therefore desired to provide a method of concentrating pulp mill extract streams. More particularly, it is desired to generally provide a method of dewatering a pulp mill waste stream to reduce the required capacity of evaporators or other traditional methods of dewatering waste streams. Conversely, it is desired to provide a method of removing organic compounds from an aqueous pulp mill waste stream in order to reduce the BOD or COD demand on a wastewater treatment system.

### BRIEF SUMMARY OF THE INVENTION

A process has been developed that separates extracted organic components from pulp mill extraction liquors. The separation concentrates the extracted organic components and purifies the extraction liquor. The organic components from the extraction liquors are effectively dewatered. The dewatered organic components may be burned or otherwise recovered without the need for heavy evaporator loading as previously required. The purified extraction liquor, which is usually an aqueous solution, may be recycled for use in pulp mill processes or may be fed to a wastewater treatment operation for further treatment.

The process comprises separating at least a portion of organic particles from the extraction liquor of a pulp mill process by passing the extraction liquor through at least one nanofiltration membrane. The separation typically occurs subsequent to washing a cellulose pulp that has undergone a pulp mill extraction process to obtain an aqueous extraction liquor containing organic particles.

The process is applicable to a broad range of extraction liquors commonly produced in operation of a pulp mill. For instance, common pulp mill operations that result in extraction liquors are kraft cooking processes, hot caustic extraction (HCE) processes, sulfite cooking processes, and bleaching processes. Extraction liquors used with these processes are typically aqueous liquors containing extraction compounds such as sodium hydroxide, sodium carbonate, sodium sulfide, sodium sulfate, sodium thiosulfate, ammonium sulfite, and chlorine salts. The organic content of the streams typically comprises at least one of lignin, carbohydrate, resins, and fatty acids.

A portion of the organic components is removed from an extraction liquor by passing that liquor through a nanofiltration membrane, preferably having a nominal molecular weight cut-off between about 200 MW and about 1000 MW. A cut-off of about 200 MW and about 1000 MW corresponds to a normal pore size of about 0.5 to about 1.5 nanometers, respectively. The desired cut-off point of the filter for any particular situation will vary somewhat depending on the content of the extract stream and process variables, but should generally be between about 200 MW and 1000 MW.

As mentioned, the dewatered organic components from the extraction liquor may be recovered or the organics may be burned to capture their energy value. Evaporators may still be required to reduce the water content of the dewatered organic components obtained by this process to a level acceptable for combustion, but the load placed on evaporators by the dewatered organic components is significantly reduced in comparison to extract streams that have not been treated in accordance with the invented method.

After removal of organics from the extraction liquor, the extraction liquor may be useful in pulp mill operations. For instance, if the extraction liquor resulted from a washing operation, the cleaned liquor may be recycled to that washing operation or to other operations within the pulp mill. If the extraction liquor is to be discharged, then the liquor may advantageously be treated in a wastewater treatment process. Because organic content has been removed from the liquor, the BOD and COD load on the treatment process is reduced. These and other advantages of the invented process will be apparent after reviewing the disclosure as a whole.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a flow diagram showing the general process of the invention;

FIG. 2 is a flow diagram showing a particular membrane filtration apparatus in accordance with an embodiment of the invention;

FIG. 3 is a flow diagram showing a particular membrane filtration apparatus in conjunction with a pre-filter in accordance with an embodiment of the invention;

FIG. 4 is a flow diagram showing an advantageous embodiment of the invention configured for treatment of spent sulfite liquor;

FIG. 5 is a flow diagram showing still another embodiment of the invention configured for treatment of kraft black liquor;

FIG. 6 is a flow diagram showing still another embodiment of the invention configured for treatment of hot caustic extract; and,

FIG. 7 is a flow diagram showing yet another embodiment of the invention configured for treatment of bleach effluent.

### DETAILED DESCRIPTION OF THE INVENTION

Hereinafter, the present inventions will now be described more fully with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

For ease of description, the terms “processing liquor” and “extraction liquor” are both used herein to refer to a pulp mill process liquor used to extract organic components from a lignocellulose material. The terms are used to identify the relative position of those materials within the pulp mill process. “Processing liquor” generally refers to relatively fresh liquor that is in combination with the lignocellulose material or that has not yet been combined with the lignocellulose material. “Extraction liquor” generally refers to a dilute aqueous organic-laden liquor that has been washed from the processed cellulose after extraction.

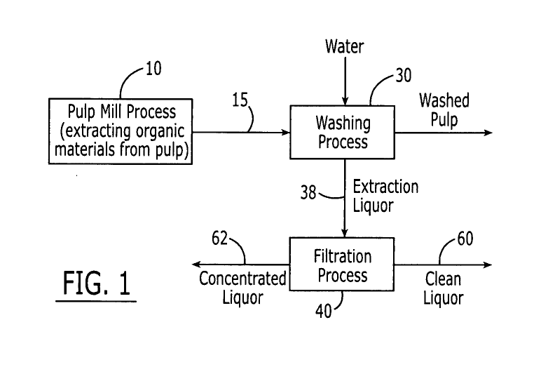

Referring to FIG. 1, lignocellulose pulp is subjected to a pulp mill process 10 that extracts at least a portion of the organic material, such as lignin, hemicellulose, resins, and/or fatty acids, from the cellulose fibers and into a processing liquor, resulting in a slurry comprised of the cellulose pulp and processing liquor. The extracted organic material may reside in the processing liquor 15 as a solution or dissolved solids. After extraction, the processing liquor is washed from the cellulose fibers by a washing process 30. The washing process typically involves passing an aqueous stream through the pulp, thereby washing the processing liquor and any extracted organics from the pulp. Washed pulp proceeds from the washing process 30. The dilute extraction liquor 38 formed by the combination of the aqueous wash stream and the processing liquor is fed to a nanofiltration process 40. The nanofiltration process 40 separates at least a portion of the organic material from the dilute liquor to form a clean liquor 60 having a lower concentration of organic material than the dilute liquor 38, and a concentrated liquor 62 having a higher concentration of organic material than the dilute liquor 38.

The pulp mill process 10 is generally any process utilized in papermaking or pulp processing that extracts organic content from a lignocellulose pulp into a liquid processing liquor. Pulp mill processes contemplated by this disclosure include but are not limited to kraft cooking processes, hot caustic extraction processes, sulfite cooking processes, and bleaching processes. The organic content of the extract is often a mixture of lignin, hemicellulose, and other impurities. In the case of kraft cooking, sulfite cooking, and hot caustic extraction, the organic content extracted from the lignocellulose is predominantly lignin and hemicellulose. In the case of bleaching, the organic content extracted from the cellulose is predominantly lignin. Several extraction processes are known in the art, and the exact amount and content of organic extracts is understood to vary with the extraction conditions.

The processing liquor varies with the type of extraction process used. Types of processing liquors and process conditions are generally known in the art. By way of example, kraft cooking uses an aqueous solution of sodium sulfide and sodium hydroxide and hot caustic extraction use an aqueous solution of sodium hydroxide. The kraft cooking process liquor may also contain sodium carbonate, sodium sulfate, and sodium thiosulfate. A sulfite cooking process typically uses an aqueous ammonium or sodium sulfite processing liquor, and bleaching processes may use aqueous solutions of chlorine, chlorine compounds, sodium hydroxide, and/or hydrogen peroxide.

The washing process 30 may be carried out in washing units as known in the art of paper production. Typical washing units comprise one or more mesh screens on which the cellulose fibers are supported as an aqueous stream, usually a fresh or recycled water stream, is allowed to flow over and through the fibers, thus washing the processing liquor and any dissolved or suspended extracts from the fibers.

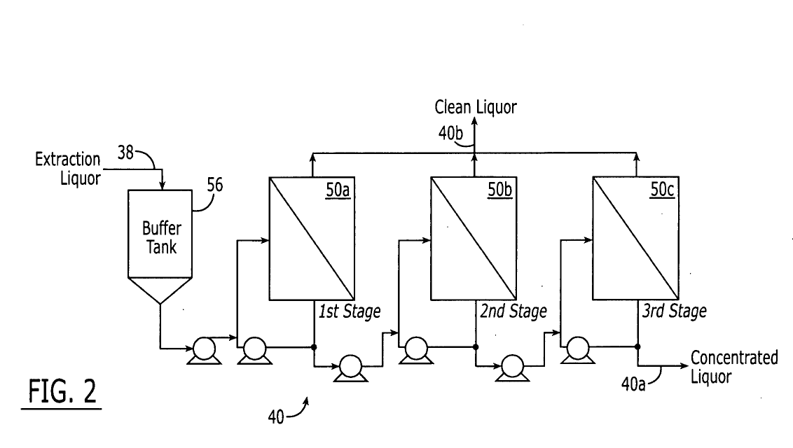

As used herein, “nanofiltration” refers to filtration through a membrane capable having a pore size of about 0.5 to 1.5 nanometers or molecular weight cut off of about 200 to 1,000. The filtration system 40 generally includes at least one filtration unit and beneficially includes a plurality of filtration units. In a beneficial embodiment illustrated in FIG. 2, the filtration system 40 includes three filtration units, 50a-50c. Each filtration unit 50a-50c may advantageously include one or more filtration membranes. In operation, it would not be unusual to feed a liquid through 10 to 15 membranes in order to achieve a desired degree of separation. An optional buffer tank 56 may be used to store the dilute liquor 38 prior to filtration.

By use of filtration membranes having the appropriate nominal molecular weight cut off or pore size, the aqueous portion and chosen components of the dilute liquor 38, i.e. those having a molecular size smaller than the molecular weight cut off of the filtration membrane, pass through the filtration membrane and exit the filtration system 40 as a permeate stream 40b. The components within the dilute liquor 38 having a molecular size larger than the nominal molecular weight cut off of the membrane, are “rejected” by the filtration membrane and exit the filtration system 40 as a concentrated liquor 40a.

Nanofiltration stands in contrast to microfiltration, which refers to filtration through a filter medium having nominal pore size of 0.05-2 microns and “ultrafiltration”, which refers to filtration through a membrane having nominal pore size of about 0.0015-0.1 microns or molecular weight cut off of about 1,000 to 200,000. Microfiltration and ultrafiltration do not provide the ability to separate dissolved hemicellulose from a pulp mill process with a molecular weight of 200 MW to 1000 MW. Nanofiltration also stands in contrast to “Reverse osmosis” (RO), which refers to separation through a membrane with nominal pore size less than about 0.5 nanometer or molecular weight cut off below about 200. Though reverse osmosis provides a high degree of separation and could be used in conjuction with the disclosed methods, use of reverse osmosis membranes is general not favored because throughput of the membranes is so low at operational pressures (500 psi-1000 psi) that use of the RO membranes is not practical.

The filtration membranes may be formed from a number of different polymers, as known in the art. More particularly, any polymer capable of withstanding the pH's associated with the various waste streams, described in more detail below, may be employed. Exemplary materials for use in forming nanofiltration membranes include many commercially available polymers such as polyether-sulfone, polysulfone, polyarylether sulfones, polyvinylidene fluoride, polyvinyl chloride, polyketones, polyether ketones, polytetrafluoroethylene, polypropylene, polyamides, cellulose acetate and mixtures thereof. The degradation properties of the foregoing polymers may further be improved by altering their molecular weight distribution, as described in U.S. Pat. No. 5,279,739. Particular membranes are advantageously chosen to match pH compatibility with the expected pH range of the dilute liquor 38 being processed.

The filtration system 40 may be operated at any temperature known in the art, such as at temperatures of up to about 70° C. In one advantageous embodiment, the filtration system is operated at a temperature of about 50° C. The pressure at which filtration is carried out is advantageously high enough to provide adequate flow through the filtration membrane to achieve desired processing efficiencies. Typically, the filtration system 40 may be operated at a hydrostatic pressure of from about 50 to about 1000 psig, advantageously from about 100 to about 1000 psig for nanofiltration filters.

In the design of membrane systems, generally, the higher desired rejection, the higher cost is for the membrane capital and operation. Once the lowest acceptable rejection is determined, experimental tests can be conducted to obtain permeate sample produced from different membranes to determine if the rejection meets the required value. After the membranes with good rejection are selected, tests can be conducted if needed to determine the permeate flow rate per unit membrane surface area at different pressure and temperature sittings, which will be used to determine the amount of membrane surface area required to handle a given flow rate.

The filtration membrane can be in a number of different configurations and is usually positioned within a cartridge type assembly or module within a larger filtration unit. Preferred membrane configurations for use in the process of the present invention are commonly referred to as “spiral wound membranes.” Spiral wound membranes typically include a centrally positioned permeate or filtrate tube and at least one sheet of a membrane with appropriate spacer and backing that is spirally wound around the permeate or filtrate tube.

Other suitable configurations include filtration units 50 containing tubular arrays of hollow fiber membranes where a plurality of hollow membrane fibers (e.g., 3 to 200) are disposed within a modular housing. Flat sheet membranes containing a series of 2 or more spaced apart filtration membrane plates or sheets can also be used as a filtration unit accordance with the present invention. Process variables such as temperature and pressure do not change dramatically with membrane configuration. However, flow rates may vary considerably depending upon available surface area and configuration of the membranes.

Membrane systems are commercially available and may be constructed according to specifications. Most manufacturers can build membrane systems based upon defined operation conditions, such as pump and membrane housings. An example of a commercial membrane system manufacturer is Crane Environmental of Trooper, Pa. Examples of membrane manufacturers include Koch Membrane Systems of Wilmington, Mass., and GE Water Technologies of Trevose, Pa.

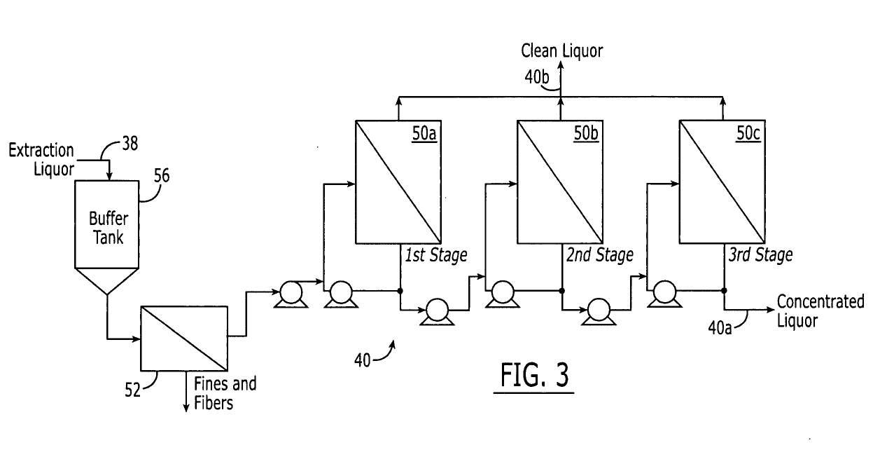

FIG. 3 illustrates an embodiment of the invention in which the filtration system 40 includes a pre-filtration unit 52 to remove larger contaminants from the dilute liquor 38 prior to filtration. The pre-filtration unit 52 is generally designed to remove contaminants having a nominal diameter of 0.1 microns or greater. Consequently, the pre-filtration unit 52 can include one or more filters having filtration size ranging from about 0.05 to 100 micron, and may include microfiltration membranes and/or ultrafiltration membranes. Suitable filters for use in the pre-filtration unit 52 include any conventional filter known in the art capable of withstanding pH conditions associated with the dilute liquor 38 being separated. Non-limiting examples of suitable pre-filters include bag filters, cartridge filters, ribbon filters and self-cleaning filters. The pre-filtration unit 52 is generally positioned prior to the membrane filtration unit 50. A buffer tank 56 may be positioned prior to the pre-filtration unit 52, or between the pre-filtration unit 52 and the filtration unit 50.

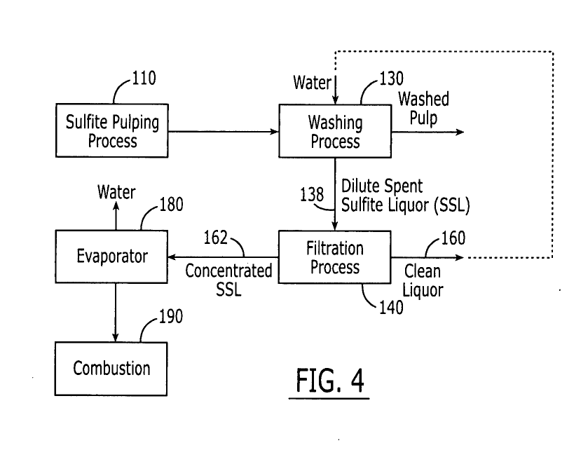

According to an advantageous embodiment, the invented method may be used to dewater a spent sulfite liquor. Referring to FIG. 4, an exemplary sulfite pulping process setup is shown. Sulfite pulping processes 110 are known in the art and generally involve cooking wood chips in a sulfite cooking liquor at a temperature between 130° C. and 180° C. The sulfite cooking liquor, a mixture of free sulfurous acid (H₂SO₃) and combined sulfurous acid in the form of bi-sulfite ion (HSO⁻₃), is produced by absorbing SO₂ in water containing an alkali, e.g., NaOH or NH₄OH. During sulfite cooking, free sulfurous acid reacts with lignin to form less soluble lignosulfonic acid, which converts to more soluble and smaller fragment lignosulfonic salts in the presence of an alkali after a series of hydrolysis reactions. During the cooking, some hemicellulose is also hydrolyzed into soluble sugars. At the end of the cooking, large amount of lignin, e.g., 70-90%, is dissolved into the cooking liquor. The wood chips are disintegrated into cellulose fibers, and form a pulp. The sulfite liquor is washed from the pulp with a washer 130. The dilute sulfite liquor 138 washed from the pulp is traditionally referred to as “spent sulfite liquor” and typically contains about 8% to about 15% total solids, 80-90% of which are organics. The organics are predominantly ligninsulfonate, hemicellulose, and extractives such as tall oil, turpentine, or resin. The spent sulfite liquor 138 is fed to a nanofiltration apparatus 140 for dewatering.

The nanofiltration apparatus 140 for use in dewatering a spent sulfite liquor preferably filters the liquor through a nanofiltration membrane with a nominal molecular weight cut off of between 200 and 1000 MW (dalton). Because the spent sulfite liquor 138 has a pH of 1-3, a membrane suitable for such a pH is advantageous. The nanofiltration apparatus 140 separates a feed of spent sulfite liquor into a clean aqueous stream 160 that comprises a lower concentration of organics and dissolved solids than the feed 138 and a concentrated spent sulfite liquor (SSL) stream 162 that comprises a higher concentration of organics and dissolved solids than the feed 138. In order to produce an acceptable flow rate of permeate through the membrane, the spent sulfite liquor is contacted with the membrane at a pressure of between about 100 and about 1000 psig. The capacity of the membrane is chosen to accommodate a given flow rate of spent sulfite liquor. Flow rates from 100 gpm to over 100,000 gpm are common in commercial pulp mills.

Because the clean stream 160 contains relatively low amounts of organics and other dissolved solids, the clean stream 160 may optionally be recycled to pulp mill processes requiring water. For instance, the clean stream 160 may be recycled to the washing process 130 and used to wash pulp from the sulfite pulping process 110. The concentrated SSL 162 is optionally fed to an evaporator 180 to further dewater the concentrated SSL. After evaporation, the concentrated SSL may be combusted in a recovery boiler 190.

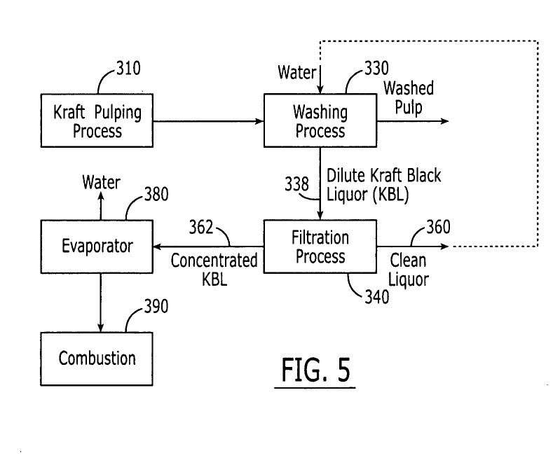

According to another embodiment, the invented process may be used to dewater a waste liquor from a kraft pulping process. Referring to FIG. 5, an exemplary kraft pulping process setup is shown in which the pulp mill process is a kraft pulping process. Kraft pulping processes 310 are known in the art and generally involve cooking wood chips in a kraft cooking liquor at a temperature between 130° C. and 180° C. The kraft cooking liquor, a mixture of sodium hydroxide and sodium sulfide, is produced from the kraft chemical recovery process with the spent kraft cooking liquor, also known as black liquor. During kraft cooking, sulfide and hydroxide react with lignin to form degraded and soluble lignin fragments in aqueous alkaline solution. During the cooking, some hemicellulose is also degraded and dissolved into the cooking liquor. At the end of the cooking, large amount of lignin, e.g., 70-90%, is dissolved into the cooking liquor. The wood chips are disintegrated into cellulose fibers, and form a pulp. The spent liquor of the kraft pulping process is washed from the pulp with a washer 330. The dilute kraft liquor that results from washing is traditionally referred to as kraft black liquor (KBL)
338. The KBL 338 washed from the pulp typically contains about 10% to about 18% total solids, 50-70% of which are organics. The organics are predominantly lignin, hemicellulose, and extractives such as tall oil, turpentine, and resin. The dilute KBL 338 is fed to a nanofiltration apparatus 340 for dewatering.

The nanofiltration apparatus 340 for use in dewatering the KBL preferably filters the liquor through a nanofiltration membrane with a molecular weight cut-off of between 200 and 1000 MW. Because the KBL 338 has a pH of 11-14, a membrane suitable for such a pH is advantageous. The nanofiltration apparatus 340 separates the feed of KBL into a clean extract stream 360 that comprises a lower concentration of organics and dissolved solids than the feed 338 and a concentrated KBL stream 362 that comprises a higher concentration of organics and dissolved solids than the feed 338. In order to produce an acceptable flow rate of permeate through the membrane, the spent sulfite liquor is contacted with the membrane at a pressure of between about 100 and about 1000 psig. The capacity of the membrane is chosen to accommodate a given flow rate of spent sulfite liquor. Flow rates from 100 gpm to over 100,000 gpm are common in commercial pulp mills.

As with the sulfite pulping embodiment above, the clean stream 360 generated from the kraft pulping process contains relatively low amounts of organics and other dissolved solids, and may optionally be recycled to pulp mill processes requiring water, such as the washer 330. The concentrated KBL extract 362 is optionally fed to an evaporator 380 to further dewater the concentrated SSL. The concentrated HCE extract may then be combusted in a recovery boiler 390.

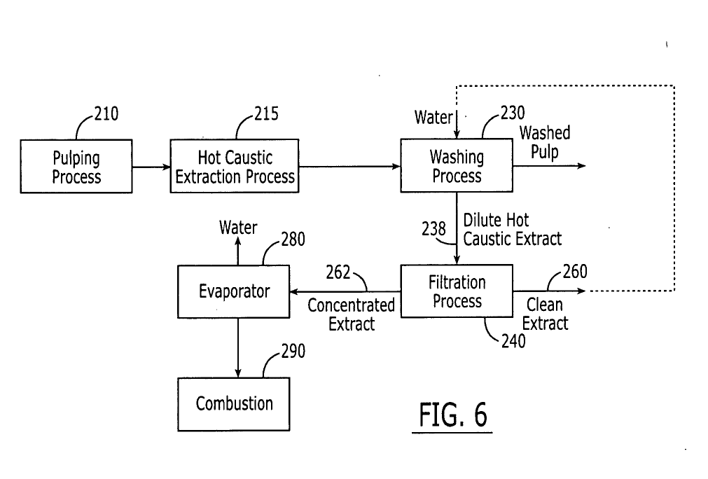

According to another embodiment, the invented process may be used to dewater a waste liquor from a hot caustic extraction (HCE) process. Referring to FIG. 6, an exemplary hot caustic extraction process is shown in which the pulp mill process may be any pulping process 210 known in the art, such as kraft pulping or sulfite pulping, where the pulping process 210 is followed by a hot caustic extraction process 215. Hot caustic extraction processes are known in the art and generally involve the application of caustic soda at a concentration of 1% to 14% directly onto a pulp mat. This mixture of pulp and caustic soda is then placed into a pressurized vessel and held at temperature for an appropriate length of time. The temperature and chemicals present act to further purify the pulp by removing ligninsulfonate, hemicellulose, sugars and other impurities not removed in previous stages. After this the pulp/HCE slurry is sent to a washing process. The HCE liquor is washed from the pulp with a washer 230. The dilute HCE liquor 238 washed from the pulp typically contains about 5% to about 8% total solids, 60-80% of which are organics. The organics are predominantly ligninsulfonate, hemicellulose, and extractives, such as tall oil, turpentine, or resin. The dilute HCE liquor 238 is fed to a nanofiltration apparatus 240 for dewatering. The dilute HCE is advantageously cooled to about 110° F. to about 120° F. prior to being nanofiltered.

The nanofiltration apparatus 240 for use in dewatering a dilute HCE liquor preferably filters the liquor through a nanofiltration membrane with a nominal molecular weight cut-off of between about 200 and about 1000 MW. Because the dilute HCE liquor 238 has a pH of 9-12, a membrane suitable for such a pH is advantageous. The nanofiltration apparatus 240 separates the feed of dilute HCE liquor into a clean extract stream 260 that comprises a lower concentration of organics and dissolved solids than the feed 238 and a concentrated HCE extract stream 262 that comprises a higher concentration of organics and dissolved solids than the feed 138. In order to produce an acceptable flow rate of permeate through the membrane, the spent sulfite liquor is contacted with the membrane at a pressure of between about 100 and about 1000 psig. The capacity of the membrane is chosen to accommodate a given flow rate of the HCE liquor. Flow rates from 50 gpm to over 50,000 gpm are common in commercial pulp mills.

Because the clean stream 260 contains relatively low amounts of organics and other dissolved solids, the clean stream 260 may optionally be recycled to pulp mill processes requiring water, such as the washer 230. The concentrated HCE extract 262 is optionally fed to an evaporator 280 to further dewater. The concentrated HCE extract may then be combusted in a recovery boiler 290.

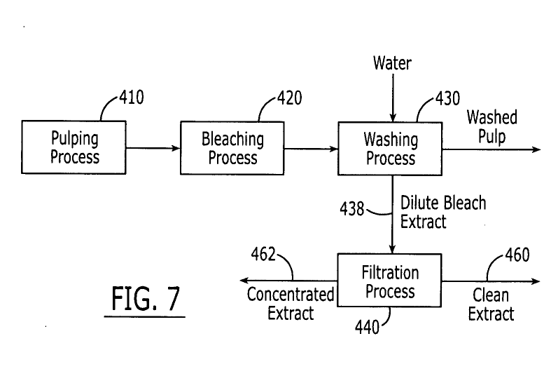

According to yet another embodiment, the invented process may be used to dewater a waste liquor from a bleaching process. Referring to FIG. 7, an exemplary bleaching process setup is shown in which the pulp mill process 410 may be any pulping process known in the art, such as kraft pulping or sulfite pulping, and where the pulping process 410 is followed by a bleaching process 420. Interceding stages may be present within a bleaching operation and the example of FIG. 7 is not intended to imply that output of a pulping process necessarily goes directly to a bleaching operation. Bleaching processes 420 are known in the art and generally involve multiple stages of treatment of the pulps with different bleaching chemicals. The chemicals used in bleaching include chlorine, chlorine dioxide, hypochlorite, hydrogen peroxide, ozone, oxygen, and sodium hydroxide. Most of these bleach chemicals degrade the residual lignin left from cooking to smaller fragments to be dissolved, and also convert the colored material remaining in the cellulose to colorless material. Sodium hydroxide is mostly used to improve the solubility of the degraded lignin fragment for better extraction. When no chlorine based chemicals are used in any of the bleaching stages, the bleaching sequence is referred as total chlorine free (TCF) bleaching. When no elemental chlorine is used, but other chlorine containing chemicals are used in any of the bleach stages, the sequence is often referred as elemental chlorine free (ECF) bleaching.

The liquor resulting from the bleaching process is washed from the pulp with a washer 430. The dilute bleach extract 438 that results from washing typically contains about 0.1% to about 2% total solids, 50-90% of which are organics. The organics are predominantly lignins. The dilute bleach effluent 438 is fed to a nanofiltration apparatus 440 for dewatering.

The nanofiltration apparatus 440 for use in dewatering the dilute bleach extract preferably filters the extract through a nanofiltration membrane with a nominal molecular weight cut-off between about 200 and about 1000 MW. Because the dilute extract has a pH of 3-10, a membrane suitable for such a pH is advantageous. The nanofiltration apparatus 440 separates the feed extract 438 into a clean extract stream 460 that comprises a lower concentration of lignins than the feed 438 and a concentrated extract 462 that comprises a higher concentration of lignin than the feed 438. In order to produce an acceptable flow rate of permeate through the membrane, the bleaching effluent is contacted with the membrane at a pressure of between about 100 and about 1000 psig. The capacity of the membrane is chosen to accommodate a given flow rate of bleach effluent. Flow rates from 100 gpm to over 100,000 gpm are common in commercial pulp mills.

The desirability of recycling cleaned bleach extract streams to the washer or of burning concentrated bleach extract streams depends upon the type of bleaching sequence from which the extract is obtained. For a TCF sequence, the concentrated bleach effluent loaded with degraded lignin and carbohydrates can be sent to the recovery boiler with associated energy recovery from combustion of the organic fraction, the clean permeate from the filtration process is advantageously sent to a waste water process because the permeate is low in COD, BOD and effluent color. Therefore, the load on the wastewater system is lower than with an unfiltered effluent. A portion of a TCF clean extract may be recycled to the washer 430.

For an ECF sequence, nanofiltration membranes may not effectively filter chlorides, so the amount of chlorides in each stream 460, 462 must be determined before the streams are discharged. Generally, chloride-laden streams should not be recycled to a recovery boiler. However, the volume of the concentrate can be made to be 1/10 or 1/20 of the feed volume. Since chlorides do not partition across the membrane, the concentration in the concentrated extract and in the cleaned extract are roughly the same. With the same concentration but substantially lower volume, the amount of chloride in the concentrated extract will be significantly reduced. So, in some circumstances the concentrated extract from an ECF sequence may be burned. The cleaned extract 460 is typically treated as wastewater.

For chlorine-based sequences, the cleaned extract 460 is optionally directed to a wastewater treatment operation and the concentrated extract 464 is also typically treated as wastewater, but may be combusted in a recovery boiler if chloride levels in the concentrate allow.

### EXAMPLES

### Example 1

### Removal of Water from Weak HCE Prior to Evaporation, Trial 1

A trial was undertaken to remove a large part of the water from a weak HCE feed having 8.0% solids and 68,500 mg/L of COD prior to evaporation.

The trial equipment consisted of a mobile nanofiltation trailer borrowed from Mobile Process Technology, Memphis, Tenn. The trailer used two separate filtration trains loaded with Hydranautics™ 1000 dalton nanofiltration membranes. Each of the trains consisted of five pressure vessels arranged in a 3:2 configuration (a set of 3 parallel membrane housings followed by a set of two parallel membrane housings). The pretreatment for the system consisted of 6 bag filter housings loaded with 1-25 micron bags and piped in series or parallel as needed. The HCE was cooled to below 103° F. to comply with the temperature limitations of the membranes used. The pH of the HCE was lowered to about 8 pH prior to the bag filters in order to comply with the maximum pH of the particular membranes used.

With the nanofilters from one of the two trailers arranged in a 3:2 configuration, permeate samples were collected and analyzed. Results of the COD and solids tests revealed that the membranes were rejecting 54% of the COD from the feed and achieving minor solids separation. The permeate recovery, i.e., amount of permeate removed from the feed, was about 50%. This resulted in a permeate with 6.5% solids and a COD of 31,800 mg/L.

The second train of membranes was put into operation with a 3:2 configuration. This resulted in 60 membranes in operation and allowed for a feed flow of 370 gpm and a permeate flow of 155 gpm.

### Example 2

### Removal of Water from Weak HCE Prior to Evaporation, Trial 2

A trial was undertaken to remove a large part of the water from a weak HCE feed having about 6.0% solids and 4% COD prior to evaporation.

The trial equipment consisted of nanofiltation unit purchased from Crane Environment, Inc, Venice, Fla., a heat exchanger, and two prefiltration units. The unit had two separate housings, each loaded with four Koch SR3 nanofiltration membranes with molecular weight cut off of 200 daltons. The first prefiltration unit removed suspended particles larger than 40 micron, and the second removed the suspended particles larger than 5 micron. The HCE was cooled to about 110° F. to comply with the temperature limitations of the membranes used. The pH of the HCE was between 9 and 11.0.

This system allowed a feed flow of 30 to 60 gpm, and produced 10 to 25 gpm permeate flow.

Results of the COD and solids tests revealed that the membranes were rejecting 80 to 90% of the COD from the feed and also achieving significant solids separation, i.e., 75 to 80%. The permeate recovery, i.e., amount of permeate removed from the feed, was about 30-40% with the first four membranes in the first housing. This resulted in a permeate with 1.0-1.5% solids and a COD of 0.3 to 0.5%.

Having the benefit of the teachings presented in the foregoing descriptions and the associated drawings, many modifications and other embodiments of the inventions set forth herein will come to mind to one skilled in the art to which these inventions pertain. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process for concentrating components from a pulp mill waste stream comprising the steps of:
subjecting a cellulose material to a pulp mill process to generate a slurry of cellulose pulp and processing liquor, wherein the pulp mill process is selected from the group consisting of a kraft cooking process, a hot caustic extraction process, a sulfite cooking process, and a bleaching process;
washing the cellulose pulp slurry to obtain an aqueous extraction liquor containing organic components; and
separating at least a portion of said organic components from the extraction liquor by passing the extraction liquor through at least one nanofiltration membrane.

2. The process of claim 1, wherein the extraction liquor is a solution of at least one extracting compound selected from the group consisting of sodium hydroxide, sodium carbonate, sodium sulfide, sodium sulfate, sodium thiosulfate, ammonium sulfite, and chlorine salts.

3. The process of claim 1, wherein the organic components are selected from the group consisting of lignin, hemicellulose, degraded cellulose, resins, fatty acids, and combinations thereof.

4. The process of claim 1, wherein the step of separating at least a portion of said organic components comprises
passing the extraction liquor through at least one nanofiltration membrane having a nominal molecular weight cut-off between about 200 and 1000 dalton.

5. The process of claim 1, wherein the step of separating at least a portion of said organic components comprises
passing the extraction liquor through at least one nanofiltration membrane having a nominal pore size between about 0.5 and about 1.5 nanometers.

6. The process of claim 5, wherein the at least one nanofiltration membrane comprises two or more membrane filters in series.

7. The process of claim 5, wherein the at least one nanofiltration membrane comprises two or more membrane filters in parallel.

8. The process of claim 4, wherein the at least one membrane filter is made of a polymer selected from the group consisting of polyether-sulfone, polysulfone, polyarylether sulfones, polyvinylidene fluoride, polyvinyl chloride, polyketones, polyether ketones, polytetrafluoroethylene, polypropylene, cellulose acetate, polyamides and mixtures thereof.

9. The process of claim 4, wherein the extraction liquor is fed to the membrane at a hydrostatic pressure from about 50 to about 1000 psig.

10. The process of claim 4, wherein the at least one membrane is selected from the group consisting of a spirally-wound membrane, flat-sheet membrane, hollow fiber membrane, and tubular array membrane.

11. The process of claim 1, further comprising the step of pre-filtering the extraction liquor through at least one filter having a pore size of 0.05 micron or larger to remove contaminants prior to the step of separating at least a portion of said organic components from the extraction liquor by passing the extraction liquor through the nanofiltration membrane.

12. A process for recovering organic components from a spent sulfite liquor, comprising the steps of:
providing a spent sulfite liquor (SSL) containing organic components; and
separating at least a portion of said organic components from the SSL by passing the SSL through at least one nanofiltration membrane.

13. The process of claim 12, wherein at least one nanofiltration membrane has a nominal molecular weight cut-off between about 200 and 1,000 dalton.

14. The process of claim 12, wherein the at least one nanofiltration membrane is stable at a pH of from about 1 to about 3.

15. The process of claim 12, further comprising the step of recycling the filtrate from the at least one nanofiltration membrane to a washing process.

16. The process of claim 12, further comprising the step of recycling the concentrated organic components from at least one nanofiltration membrane to an evaporation process.

17. A process for concentrating organic components from a kraft pulping process waste liquor, comprising the steps of:
providing a kraft pulping process waste liquor containing organic components; and,
separating at least a portion of said organic components from the waste liquor by passing the waste liquor through at least one nanofiltration membrane.

18. The process of claim 17, wherein the at least one nanofiltration membrane has a nominal molecular weight cut-off between about 200 and about 1,000 dalton.

19. The process of claim 17, wherein the at least one nanofiltration membrane is stable at a pH of from about 11 to about 14.

20. The process of claim 17, further comprising the step of recycling the filtrate from the at least one nanofiltration membrane to a washing process.

21. The process of claim 17, further comprising the step of recycling the concentrated organic components from the at least one nanofiltration membrane to an evaporation process.

22. A process for concentrating organic components from a hot caustic extraction process waste liquor, comprising the steps of:
providing a hot caustic extraction process waste liquor containing organic components; and,
separating at least a portion of said organic components from the waste liquor by passing the waste liquor through at least one nanofiltration membrane.

23. The process of claim 22, wherein the at least one membrane filter has a nominal molecular weight cut-off between about 200 and about 1,000 dalton.

24. The process of claim 22, wherein the at least one nanofiltration membrane is stable at a pH of from about 9 to about 12.

25. The process of claim 22, further comprising the step of recycling the filtrate from at least one nanofiltration membrane to a pulp mill washing process or waster water treatment process.

26. The process of claim 22, further comprising the step of recycling the concentrated solids from the at least one nanofiltration membrane to an evaporation process.

27. A process for concentrating organic components from a pulp mill bleaching process waste liquor, comprising the steps of:
providing a pulp mill bleaching process waste liquor containing organic components; and,
separating at least a portion of said organic components from the waste liquor by passing the waste liquor through at least one nanofiltration membrane.

28. The process of claim 27, wherein the at least one nanofiltration membrane has a nominal molecular weight cut-off of between about 200 and about 1,000 dalton.

29. The process of claim 27, wherein the at least one nanofiltration membrane is stable at a pH of from about 3 to about 10.

30. The process of claim 27, further comprising the step of recycling the filtrate from the at least one nanofiltration membrane to a wastewater treatment process.

31. The process of claim 27, further comprising the step of recycling the concentrated organic components from the at least one nanofiltration membrane to an evaporation process.
